(19) United States
(12) Patent Application Publication
(10) Pub. No.: US 2025/0103848 A1
(43) Pub. Date: Mar. 27, 2025

(54) INTELLIGENT VIRTUAL ASSIST FOR RESOURCE ADVANCEMENT

(71) Applicant: BANK OF AMERICA CORPORATION, cHARLOTTE, NC (US)

(72) Inventors: Pratap Dande, Saint Johns, FL (US); Amer Ali, Jersey City, NJ (US); Erik Dahl, Newark, DE (US); Brian Neal Jacobson, Los Angeles, CA (US); Elvis Nyamwange, Little Elm, TX (US); Rahul Shashidhar Phadnis, Charlotte, NC (US); Sailesh Vezzu, Hillsborough, NJ (US); Hari Vuppala, Charlotte, NC (US); Rahul Yaksh, Austin, TX (US)

(73) Assignee: BANK OF AMERICA CORPORATION, Charlotte, NC (US)

(21) Appl. No.: 18/372,394

(22) Filed: Sep. 25, 2023

(51) Int. Cl. G06N 3/006

(52) U.S. Cl. CPC G06N 3/006

(57) ABSTRACT

Intelligent autonomous software (i.e., a “bot”) configured to compile and present resource advancement requestor-specific dashboards that summarize the results of analysis of resource advancement data related to the resource advancement request/requestor. In compiling a dashboard presentation for a specific resource advancement requestor, the intelligent autonomous software executes a set of predetermined queries directed to a database that stores the results of the data analysis. In response to receiving the responses to the queries, the intelligent autonomous software is configured to identify data omissions/anomalies in the data that will prevent approval of the resource advancement request and identify, and in some instances generate, corrective action(s) that will rectify the data omissions/anomalies. Subsequently, a resource advancement requestor-specific dashboard presentation is generated and communicated to the user that (i) summarizes the data responsive to the predetermined queries, and (ii) highlights the data omissions/anomalies and the corrective actions necessary to rectify the data omissions/anomalies.

### FIELD OF THE INVENTION

The present invention is related generally to intelligent autonomous software and, more specifically, using intelligent autonomous software (i.e., a “bot”) as a virtual assist in compiling a summary dashboard for a user in decision-making resource advancements.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that implement the use of intelligent autonomous software (i.e., a “bot”) to compile and present resource advancement requestor-specific dashboards that summarize the results of analysis of resource advancement data related to the resource advancement requestor and the resource advancement. In this regard, the dashboard allows user to efficiently and effectively decision resource advancement requests.

Specifically, in compiling a dashboard presentation for a specific resource advancement requestor the intelligent autonomous software is configured to execute a set of predetermined queries directed to a database that stores the results of the data analysis. In response to receiving the responses to the queries, the intelligent autonomous software is configured to identify data omissions and/or other anomalies in the data that will prevent approval of the resource advancement request and identify, and in some instances generate, corrective action(s) that will rectify the data omissions/anomalies. Subsequently, a resource advancement requestor-specific dashboard presentation is generated and communicated to the user that (i) summarizes the data responsive to the predetermined queries, and (ii) highlights the data omissions/anomalies and includes the corrective actions necessary to rectify the data omissions/anomalies.

In addition, the dashboard is configured to receive on-demand queries from the user which are received and executed by the intelligent autonomous software, which, in tune, updates the dashboard presentation with the results of the on-demand queries. In response to receiving on-demand queries, a machine-learning model within the intelligent autonomous software is configured to receive the on-demand queries and determine whether or not the on-demand queries should added to the set of predetermined queries, thereby modifying the dashboard presentation for all subsequent resource advancement requestors (i.e., determine whether the information resulting from the on-demand queries would be beneficial to users decisioning future resource advancement requests).

Moreover, in further embodiments of the invention, the data analysis performed on resource advancement request/requestor data includes intelligent data verifications and/or data assessments, such that the user of the dashboard presentation can accept the information presented therein as factual without the need to perform their own verification/assessments. In this regard, the data analysis may include one or more machine learning (ML) models. For example, the ML model(s) may include, one or more of, (i) an ML model configured to verify the incoming resources (e.g., wages or the like) of the resource advancement requestor, (ii) an ML model configured to assess the value of the real resources (e.g., real property or the like) held/owned by the resource advancement requestor, (iii) an ML configured to assess the value to the target of the resource advancement (e.g., real property, vehicle or the like) and (iv) an ML model configured to verify the resource advancement worthiness of the resource advancement requestor (e.g., credit worthiness of the resource advancement requestor or the like).

A system for processing a resource advancement request defines first embodiments of the invention. The system includes a first computing platform having a first memory and one or more first computing processor devices in communication with the first memory. In addition, the system includes an autonomous and intelligent virtual assist engine (e.g., a “bot”) that is stored in the first memory and executable by at least one of the one or more first computing processor devices. The autonomous and intelligent virtual assist engine is configured to execute predetermined resource advancement queries by accessing a database storing resource advancement request data and receive first resource advancement request data responsive to the predetermined resource advancement queries. Further, the autonomous and intelligent virtual assist engine is configured to identify, based on the execution of the queries, one or more data omissions or anomalies that prevent resource advancement processing and, in response, generate, for each data omission or anomaly, one or more recommended actions for addressing the data omission or anomaly. In addition, the autonomous and intelligent virtual assist engine is configured to transform at least the first resource advancement request data into a format compatible for dashboard presentation, compile a resource advancement assessment dashboard presentation that (i) is specific to the resource advancement requestor, (ii) summarizes the first resource advancement request data, (iii) identifies the one or more data omissions or anomalies and (iv) includes the one or more recommended actions for addressing the data omission or anomaly, and present the resource advancement assessment dashboard presentation to a user that interacts with resource advancement assessment dashboard presentation for purposes of decisioning the resource advancement request.

In specific embodiments of the system, the autonomous and intelligent virtual assist engine is further configured to receive, via the resource advancement assessment dashboard, at least one on-demand resource advancement query from the user and execute the at least one on-demand resource advancement query by accessing the database storing resource advancement request data and receiving second resource advancement request data responsive to the on-demand resource advancement queries. In addition, the autonomous and intelligent virtual assist engine is configured to transform the second resource advancement request data into the format compatible for dashboard presentation, update the resource advancement assessment dashboard presentation to include the second resource advancement request data, and present the updated resource advancement assessment dashboard presentation to the user. In related embodiments of the system, the autonomous and intelligent virtual assist engine a machine learning (ML) model configured to determine whether the at least one on-demand resource advancement query should be included in the predetermined resource advancement queries require and, if a determination is made that an on-demand resource advancement query warrants inclusion in the set of predetermined resource advancement queries, modifying the set of predetermined resource advancement queries so as to include the on-demand resource advancement query.

In other specific embodiments the system further includes a second computing platform having a second memory and one or more second computing processor devices in communication with the second memory. The second memory stores a data analysis engine that is executable by at least one of the one or more second computing processor devices. The data analysis engine is configured to perform data verifications and data assessments on the resource advancement request data prior to storing the resource advancement request data in the database. In specific embodiments of the system, the data analysis engine includes one or more machine learning (ML) models. The ML models may include an incoming resource verification machine learning (ML) model configured to receive data related to incoming resources associated with the resource advancement requestor and based on the data, verify at least source and volume of incoming resources. In other embodiments of the system, the ML models may include a real resource value assessment machine learning (ML) model configured to receive data related to one or more real resources held by a resource advancement requestor and based on the data, assess a value of real resources held by a resource advancement requestor. In further specific embodiments of the system, the ML models include a resource advancement worthiness verification machine learning (ML) model configured to receive data related to resource advancement worthiness of a resource advancement requestor and based on the data, verify the resource advancement worthiness of the resource advancement requestor. In still further specific embodiments of the system, the ML models include a resource advancement target assessment machine learning (ML) model configured to receive data related to a resource advancement target that is a basis for the resource advancement and, based on the data, assess a value of the resource advancement target.

A computer-implemented method for processing a resource advancement request defines second embodiments of the invention. The method is executable by one or more computing processor devices. The method includes executing predetermined resource advancement queries for a resource advancement requestor by accessing a database storing resource advancement request data for a plurality of resource advancement requestors and receiving first resource advancement request data from the database responsive to the predetermined resource advancement queries. The computer-implemented method further includes identifying, based on the execution of the predetermined resource advancement queries, one or more data omissions or anomalies that prevent resource advancement processing and, in response, generating, for each data omission or anomaly, one or more recommended actions for addressing the data omission or anomaly. Further, the computer-implemented method includes transforming at least the first resource advancement request data into a format compatible for dashboard presentation, compiling a resource advancement assessment dashboard presentation that (i) is specific to the resource advancement requestor, (ii) summarizes the first resource advancement request data, (iii) identifies the one or more data omissions or anomalies and (iv) includes the one or more recommended actions for addressing the data omission or anomaly, and presenting the resource advancement assessment dashboard presentation to a user that interacts with resource advancement assessment dashboard presentation for purposes of decisioning the resource advancement request.

In further embodiments the computer-implemented method further includes receiving, via the resource advancement assessment dashboard, at least one on-demand resource advancement query from the user and executing the at least one on-demand resource advancement query by accessing the database storing resource advancement request data and receiving second resource advancement request data that forms second responses to the on-demand resource advancement queries. In addition, the computer-implemented method further includes transforming the second resource advancement request data into the format compatible for dashboard presentation, updating the resource advancement assessment dashboard presentation to include the second resource advancement request data, and presenting the updated resource advancement assessment dashboard presentation to the user. In related embodiments, the computer-implemented method includes receiving, at a Machine Learning (ML) model, the at least one on-demand resource advancement query, executing the ML model to determine whether the predetermined resource advancement queries require modification based on the at least one on-demand resource advancement query, and in response to determining that the predetermined resource advancement queries require modification, modifying the predetermined resource advancement queries.

In other specific embodiments the computer-implemented method further includes performing data verifications and data assessments on the resource advancement request data prior to storing the resource advancement request data in the database. In such embodiments of the computer-implemented method, performing data verifications and data assessments on the resource advancement request data may include receiving, at a Machine Learning (ML) model), data related to incoming resources associated with a resource advancement requestor and, in response to receiving the data, executing the ML model to verify at least source and volume of incoming resources. In other such embodiments of the computer-implemented method, performing data verifications and data assessments on the resource advancement request data may include receiving, at a Machine Learning (ML) model), data related to one or more real resources held by a resource advancement requestor and, in response to receiving the data, executing the ML model to assess a value of real resources held by a resource advancement requestor. In further such embodiments of the computer-implemented method, performing data verifications and data assessments on the resource advancement request data may include receiving, at a Machine Learning (ML) model), data related to resource advancement worthiness of a resource advancement requestor and, in response to receiving the data, executing the ML model to verify the resource advancement worthiness of the resource advancement requestor. Moreover, in other such embodiments of the computer-implemented method, performing data verifications and data assessments on the resource advancement request data may include receiving, at a Machine Learning (ML) model), data related to a resource advancement target that is a basis for the resource advancement and, in response to receiving the data, executing the ML model to assess a value of the resource advancement target.

A computer program product including a non-transitory computer-readable medium defines third embodiments of the invention. The computer-readable medium includes sets of codes for causing one or more computing devices to execute predetermined resource advancement queries for a resource advancement requestor by accessing a database storing resource advancement request data for a plurality of resource advancement requestors and receiving first resource advancement request data from the database responsive to the predetermined resource advancement queries. The computer-readable medium further includes sets of codes for causing the computing device(s) to identify, based on the execution of the predetermined resource advancement queries, one or more data omissions or anomalies that prevent resource advancement processing and, in response to identifying, generate, for each data omission or anomaly, one or more recommended corrective actions for addressing the data omission or anomaly. In addition, the computer-readable medium further includes sets of codes for causing the computing device(s) to (a) transform the first resource advancement request data and the recommendations actions into a format compatible for dashboard presentation, (b) compile a resource advancement assessment dashboard presentation specific to the resource advancement requestor that (i) summarizes the first responses to the predetermined resource advancement queries, (ii) identifies the one or more data omissions or anomalies and (iii) includes the one or more recommended actions for addressing the data omission or anomaly, and (c) present the resource advancement assessment dashboard presentation to a user that interacts with resource advancement assessment dashboard presentation for purposes of decisioning the resource advancement request.

In specific embodiments of the computer program product, the sets of codes further include sets of codes for causing the computing device(s) to receive, via the resource advancement assessment dashboard, at least one on-demand resource advancement query from the user and execute the at least one on-demand resource advancement query by accessing the database storing resource advancement request data and receiving second resource advancement request data responsive to the on-demand resource advancement queries. In such embodiments of the computer program, the sets of codes further cause the computing device(s) to transform the second resource advancement request data into the format compatible for dashboard presentation, update the resource advancement assessment dashboard presentation to include the second resource advancement request data, and present the updated resource advancement assessment dashboard presentation to the user.

In still further specific embodiments of the computer program product, the sets of codes further includes sets of codes configured to cause the one or more computing devices to receive, at a Machine Learning (ML) model, the at least one on-demand resource advancement query and execute the ML model to determine whether the predetermined resource advancement queries require modification based on the at least one on-demand resource advancement query. In response to determining that the predetermined resource advancement queries require modification, the sets of codes further cause the computing device(s) to modify the predetermined resource advancement queries.

Moreover, in additional specific embodiments of the computer program product, the sets of codes further comprise sets of codes configured to cause the one or more computing devices to perform data verifications and data assessments on the resource advancement request data prior to storing the resource advancement request data in the database.

Thus, according to embodiments of the invention, which will be discussed in greater detail below, the present invention provides for implement the use of intelligent autonomous software (i.e., a “bot”) to compile and present resource advancement requestor-specific dashboards that summarize the results of analysis of resource advancement data related to the resource advancement requestor and the resource advancement. Specifically, in compiling a dashboard presentation for a specific resource advancement requestor the intelligent autonomous software is configured to execute a set of predetermined queries directed to a database that stores the results of the data analysis. In response to receiving the responses to the queries, the intelligent autonomous software is configured to identify data omissions and/or other anomalies in the data that will prevent approval of the resource advancement request and identify, and in some instances generate, corrective action(s) that will rectify the data omissions/anomalies. Subsequently, a resource advancement requestor-specific dashboard presentation is generated and communicated to the user that (i) summarizes the data responsive to the predetermined queries, and (ii) highlights the data omissions/anomalies and includes the corrective actions necessary to rectify the data omissions/anomalies.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for resource advancement processing, in accordance with embodiments of the present invention;

FIG. 2 is a schematic/block diagram of an alternate system for resource advancement processing; in accordance with embodiments of the present invention;

FIG. 3 is a schematic/block diagram of an alternate system for resource advancement processing; in accordance with embodiments of the present invention;

FIG. 4 is a block/schematic diagram of a data analysis engine including various machine learning configured for data verifications/assessments associated with resource advancement requests, in accordance with embodiments of the present invention;

FIG. 5 is a block diagram of a computing platform including an autonomous and intelligent virtual assist engine configured for compiling a dashboard presentation for assisting a user in decisioning a resource advancement request, in accordance with embodiments of the present invention;

FIG. 6 is a flow diagram of a methodology for processing a resource advancement request, in accordance with embodiments of the present invention;

FIG. 7 is a flow diagram of a methodology for processing a resource advancement request, in accordance with embodiments of the present invention; and

FIG. 8 is a general flow diagram for generating/training and implementing machine learning models, in accordance with embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that providing for implement the use of intelligent autonomous software (i.e., a “bot”) to compile and present resource advancement requestor-specific dashboards that summarize the results of analysis of resource advancement data related to the resource advancement requestor and the resource advancement. In this regard, the dashboard allows user to efficiently and effectively decision resource advancement requests.

Specifically, in compiling a dashboard presentation for a specific resource advancement requestor the intelligent autonomous software is configured to execute a set of predetermined queries directed to a database that stores the results of the data analysis. In response to receiving the responses to the queries, the intelligent autonomous software is configured to identify data omissions and/or other anomalies in the data that will prevent approval of the resource advancement request and identify, and in some instances generate, corrective action(s) that will rectify the data omissions/anomalies. Subsequently, a resource advancement requestor-specific dashboard presentation is generated and communicated to the user that (i) summarizes the data responsive to the predetermined queries, and (ii) highlights the data omissions/anomalies and includes the corrective actions necessary to rectify the data omissions/anomalies.

In addition, the dashboard is configured to receive on-demand queries from the user which are received and executed by the intelligent autonomous software, which, in tune, updates the dashboard presentation with the results of the on-demand queries. In response to receiving on-demand queries, a machine-learning model within the intelligent autonomous software is configured to receive the on-demand queries and determine whether or not the on-demand queries should added to the set of predetermined queries, thereby modifying the dashboard presentation for all subsequent resource advancement requestors (i.e., determine whether the information resulting from the on-demand queries would be beneficial to users decisioning future resource advancement requests).

Moreover, in further embodiments of the invention, the data analysis performed on resource advancement request/requestor data includes intelligent data verifications and/or data assessments, such that the user of the dashboard presentation can accept the information presented therein as factual without the need to perform their own verification/assessments. In this regard, the data analysis may include one or more machine learning (ML) models. For example, the ML model(s) may include, one or more of, (i) an ML model configured to verify the incoming resources (e.g., wages or the like) of the resource advancement requestor, (ii) an ML model configured to assess the value of the real resources (e.g., real property or the like) held/owned by the resource advancement requestor, (iii) an ML configured to assess the value to the target of the resource advancement (e.g., real property, vehicle or the like) and (iv) an ML model configured to verify the resource advancement worthiness of the resource advancement requestor (e.g., credit worthiness of the resource advancement requestor or the like).

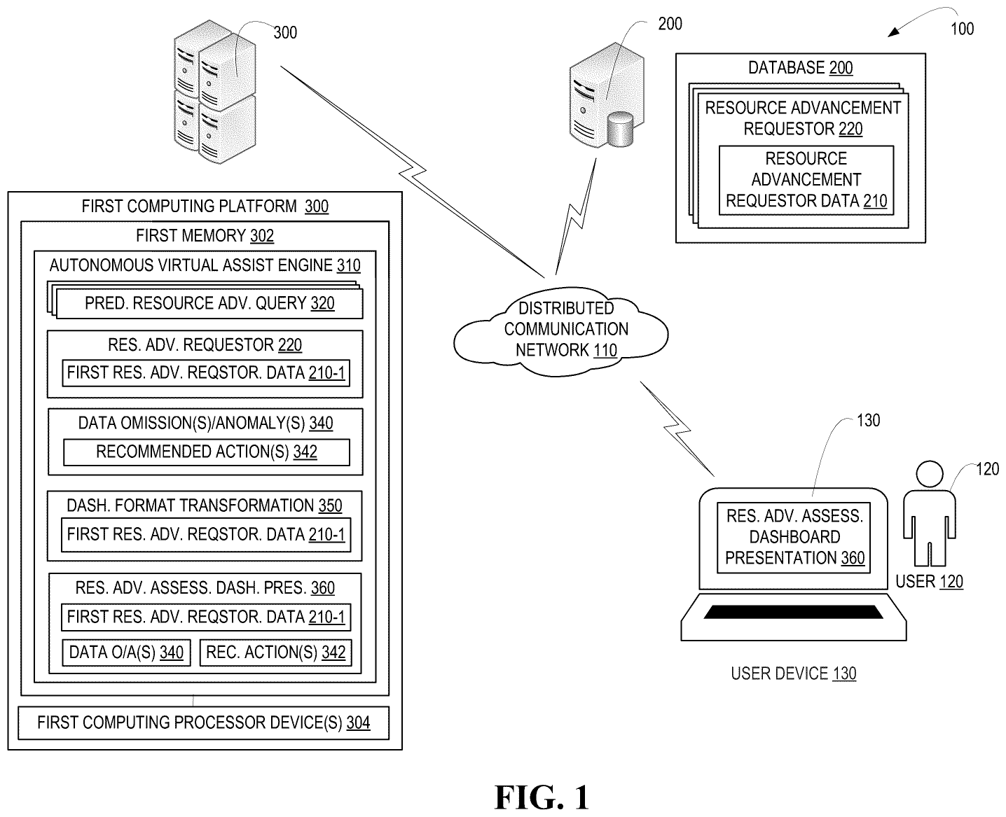

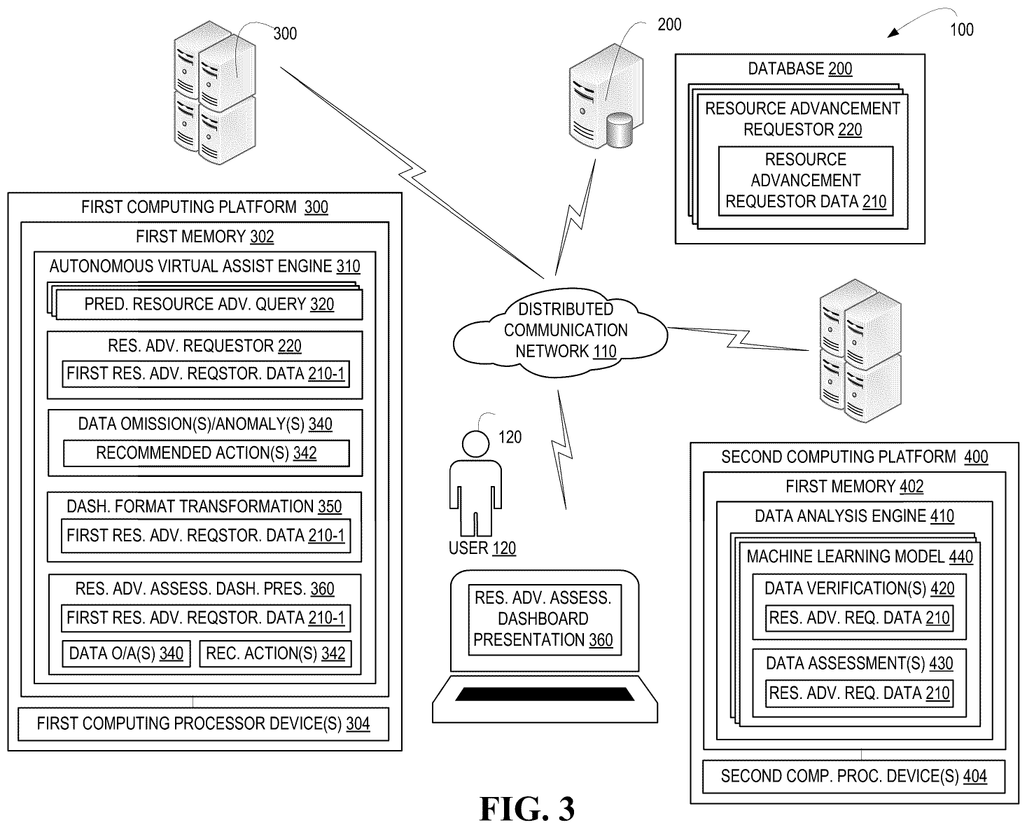

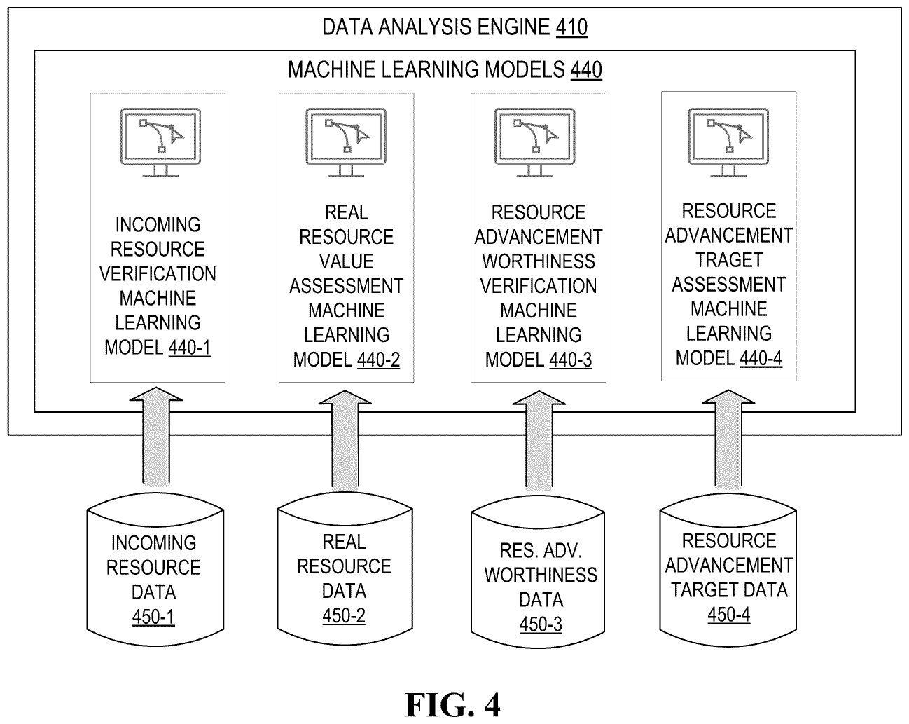

Referring to FIG. 1, a schematic/block diagram is presented of a system 100 for processing, in accordance with embodiments of the invention. The system 100 is implemented in conjunction with a distributed communication network 110 that may include the Internet, one or more intranets, one or more cellular networks or the like. System 100 includes database 200 that stores resource advancement requestor/request data 210 for a plurality of resource advancement requestors 220. In specific embodiments of the system, such as those discussed in relation to FIGS. 3 and 4, the resource advancement requestor/request data 210 will have undergone data analysis, such as data verifications and/or data assessments prior to storing resource advancement requestor/request data 210 in the database 200.

Additionally, system 100 includes first computing platform 300, which may comprise an application server(s) or the like. First computing platform 300 includes first memory 302 and one or more first computing processor devices 304 in communication with memory 302. First memory 302 stores autonomous virtual assist (e.g., a so-called “bot” or the like) engine 310 that is executable by at least one of first computing processor device(s) 304 and is configured to compile a resource advancement (e.g., loan or the like) dashboard presentation for a specific resource advancement requestor (e.g., loan applicant or the like). In this regard, autonomous virtual assist engine 310 is configured to execute a set of predetermined resource advancement queries 320 for a specific resource advancement request (e.g., loan applicant/applicant or the like) by accessing the database 200 storing the resource advancement request/requestor data 210 for the plurality of resource advancement requestors 220 and, in response, receiving first resource advancement request/requestor data 210-1 responsive to the predetermined resource advancement queries 320.

In response to receiving first resource advancement request/requestor data 210-1, autonomous virtual assist engine 310 is configured to identify one or more data omissions/anomalies 340 that prevent resource advancement processing, and, in response, identify and/or generate, for each data omission/anomaly 340, one or more recommended actions 342 for addressing the data omission/anomaly 340.

As a means of compiling the resource advancement assessment dashboard presentation 360, autonomous virtual assist engine 310 is configured to perform dashboard format transformation 350 on the first resource advancement request/requestor data 210-1 to transform or otherwise convert the first resource advancement request/requestor data 210-1 to a format compatible for dashboard presentation. In response to transformation, autonomous virtual assist engine 310 is configured to compile the resource advancement assessment dashboard presentation 360, which is (i) is specific to the resource advancement requestor (e.g., loan applicant), (ii) summarizes and/or organizes the first resource advancement requestor data 210-1, (iii) identifies the one or more data omissions/anomalies 340 and (iv) includes the one or more recommended actions 342 for addressing the data omission(s)/anomalies 342.

In response to compiling resource advancement assessment dashboard presentation 360, autonomous virtual assist engine 310 is configured to communicate the resource advancement assessment dashboard presentation 360 to the user 120 for presentation on a dashboard application (not shown in FIG. 1) executing on an associated user device 130. The resource advancement assessment dashboard presentation 360 allows the user to efficiently and effectively decision the resource advancement request since the data presented in the dashboard has already undergone automated verification and/or assessment. In this regard, the user 120 (e.g., loan officer or the like) does not have to physically or otherwise access resource advancement request documentation (e.g., loan application or other supporting documentation), since the automated data verification/assessment has performed these functions.

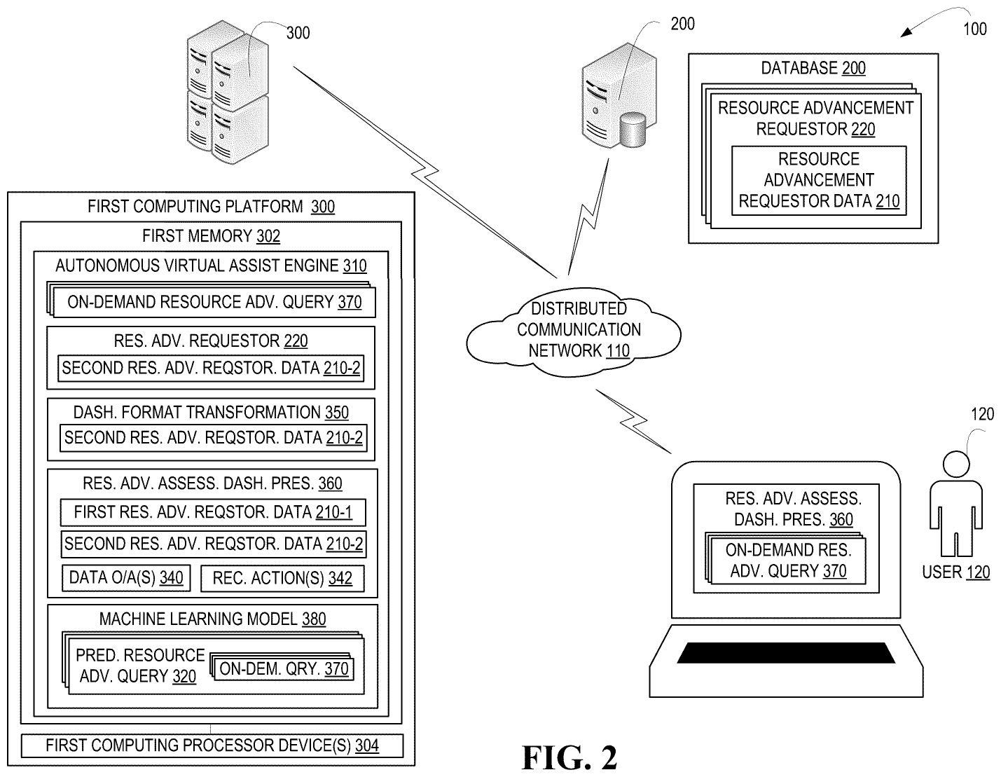

Referring to FIG. 2, a block diagram is presented of a system 100 for processing resource advancements, in accordance with embodiments of the present invention. The system 100 shown in FIG. 2 is equivalent to the system 100 shown and described in relation to FIG. 1 with the exception of additional optional functionality associated with the autonomous virtual assist engine 310. Accordingly, the autonomous virtual assist engine 310 is further configured to receive, via the resource advancement assessment dashboard application executing on user device 130, at least one on-demand resource advancement query 370 (i.e., queries inputted by user 120). In response to receiving the on-demand queries 370, autonomous virtual assist engine 310 is further configured to execute the one-demand resource advancement query(s) 370 by accessing the database 200 storing the resource advancement request/requestor data 210 and receiving second resource advancement request data 210-2 responsive to the on-demand resource advancement query(s) 370.

In response to receiving the second resource advancement request/requestor data 210-2, autonomous virtual assist engine 310 is further configured to perform dashboard format transformation 350 on the second resource advancement request/requestor data 210-2 to transform/convert the data 210-2 into a format compatible for dashboard presentation. In response to transformation 350, autonomous virtual assist engine 310 is further configured to update the resource advancement assessment dashboard presentation 360 to include the second resource advancement request/requestor data 210-1 and communicate the resource advancement assessment dashboard presentation 360 to the user 120 for presentation on a dashboard application (not shown in FIG. 1) executing on an associated user device 130.

Additionally, autonomous virtual assist engine or some other engine, module or the like includes a predetermined query-determining Machine Learning (ML) model 380 that has been trained to determine whether an on-demand query 370 should be included within the set of predetermined queries 320 (i.e., whether data 210-2 resulting from the on-demand query is relevant to all resource advancement requests). In this regard, Machine Learning (ML) model 380 receives an on-demand resource advancement query 370 and determines whether the on-demand resource advancement query 370 warrants inclusion in the set of predetermined resource advancement queries 320. If a determination is made by ML model 380 that the on-demand resource advancement query 370 should be included in the set of predetermined resource advancement queries 320, the set of predetermined resource advancement queries 320 is modified so as to include the on-demand resource advancement query 320.

Referring to FIG. 3, a block diagram is presented of a system 100 for processing resource advancements, in accordance with embodiments of the present invention. The system 100 shown in FIG. 3 is equivalent to the system 100 shown and described in relation to FIG. 1 with the exception of the addition of second computing platform 400 and the data analysis engine 410 included therein. Second computing platform 400, which may comprise an application server(s) or other computing device(s) includes second memory 402 and one or more second computing processor devices 404 in communication with memory 402. Memory 402 stores data analysis engine which is executable by at least one of the second computing processor device(s) 404 and configured to perform data verifications 420 and data assessments 430 on the resource advancement request data 210 prior to storing the resource advancement request data 210 in the database 200. In specific embodiments of the system 100, data analysis engine 410 includes a one or more machine learning models 440 that are configured to perform data verifications 420 and data assessments 430 on the resource advancement request data 210. Exemplary ML models 440 are shown and discussed in relation to FIG. 4, infra.

Referring to FIG. 4, a block/schematic diagram is depicted of data analysis 410 including various machine learning (ML) models 440, in accordance with embodiments of the present invention. The ML models 440 include incoming resource verification ML model 440-1 that is configured to receive incoming resource data 450-1 and verify the incoming resources (e.g., wages and the like) of the resource advancement requestor (e.g., loan applicant). Incoming resource data 450-1 may include, but is not limited to, tax returns, pay stubs, W2 tax forms, financial institution account statements, credit history reports, and the like. Additionally, ML models 440 include real resource value assessment ML model 440-2 that is configured to receive real resource data 450-2 and assess the value of the real resources (e.g., real estate/property and the like) of the resource advancement requestor (e.g., loan applicant). Real resource data 450-2 may include, but is not limited to, real property values, real property taxes, and real property data including location and build date.

In addition, ML models 440 include real resource value assessment ML model 440-3 that is configured to receive resource advancement worthiness data 450-3 and verify resource advancement worthiness (e.g., credit verification) of the resource advancement requestor (e.g., loan applicant). Resource advancement worthiness data 450-3 may include, but is not limited to, credit check ratings and the like. Moreover, ML models 440 include resource advancement target value assessment ML model 440-4 that is configured to receive resource advancement target data 450-4 and assess the value of the target/collateral (e.g., real property, vehicle or the like) of the resource advancement (e.g., loan). Resource advancement target data 450-4 may include, but is not limited to, property estimates and conditional values data and the like.

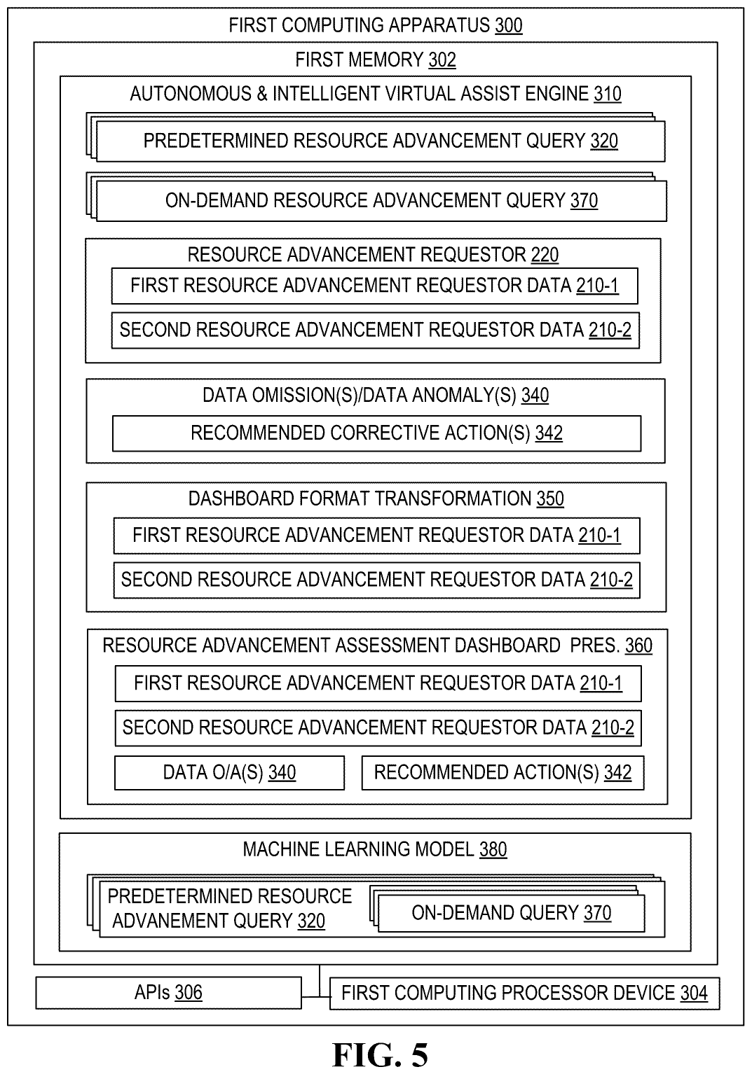

Referring to FIG. 5, a block diagram is presented of first computing platform 300, in accordance with embodiments of the present invention. In addition to providing greater details of first computing platform 300, FIG. 5 highlights various alternate embodiments of the invention. First computing platform 300 may comprise one or, typically, multiple devices, such as application servers and the like. First computing platform 300 includes first memory 302, which may comprise volatile and/or non-volatile memory, such as read-only memory (ROM) and/or random-access memory (RAM), EPROM, EEPROM, flash cards, or any memory common to computing platforms. Moreover, first memory 302 may comprise cloud storage, such as provided by a cloud storage service and/or a cloud connection service.

Further, first computing platform 300 includes one or more first computing processing devices 304, which may be an application-specific integrated circuit (“ASIC”), or other chipset, logic circuit, or other data processing device. First computing processing device(s) 304 may execute one or more application programming interface (APIs) 306 that interface with any resident programs, such as autonomous/intelligent virtual assist engine 310 or the like, stored in first memory 302 of first computing platform 30 and any external programs. First computing platform 300 may include various processing subsystems (not shown in FIG. 5 embodied in hardware, firmware, software, and combinations thereof, that enable the functionality of first computing platform 300 and the operability of first computing platform 300 on a distributed communication network 110 (shown in FIGS. 1-3), such as the Internet, intranet(s), cellular network(s) and the like. For example, processing subsystems allow for initiating and maintaining communications and exchanging data with other networked devices. For the disclosed aspects, processing subsystems of first computing platform 300 may include any subsystem used in conjunction with autonomous/intelligent virtual assist engine 310 and related tools, routines, sub-routines, applications, sub-applications, sub-modules thereof.

In specific embodiments of the present invention, first computing platform 300 additionally includes a communications module (not shown in FIG. 5) embodied in hardware, firmware, software, and combinations thereof, that enables electronic communications between components of first computing platform 300 and other networks and network devices. Thus, communication module may include the requisite hardware, firmware, software and/or combinations thereof for establishing and maintaining a network communication connection with one or more devices and/or networks.

As previously discussed, first memory 302 stores autonomous virtual assist engine 310 that is configured to execute a set of predetermined resource advancement queries 320 for a specific resource advancement request (e.g., loan applicant/applicant or the like) by accessing the database 200 (shown in FIGS. 1-3) storing the resource advancement request/requestor data 210 for the plurality of resource advancement requestors 220. In response, receiving first resource advancement request/requestor data 210-1 responsive to the predetermined resource advancement queries 320. The execution of the queries may be triggered by the user 110 (shown in FIGS. 1-3) requesting a dashboard presentation 360 for a specific resource advancement request or requestor.

In response to receiving first resource advancement request/requestor data 210-1, autonomous virtual assist engine 310 is configured to identify one or more data omissions/anomalies 340 that prevent resource advancement processing (e.g., impediments to approving the loan request), and, in response, identify and/or generate, for each data omission/anomaly 340, one or more recommended actions 342 for addressing the data omission/anomaly 340 (i.e., what the user or resource advancement requestor needs to provide or perform to rectify the data omission/anomaly).

As a means of compiling the resource advancement assessment dashboard presentation 360, autonomous virtual assist engine 310 is configured to perform dashboard format transformation 350 on the first resource advancement request/requestor data 210-1 to transform or otherwise convert the first resource advancement request/requestor data 210-1 to a format compatible for dashboard presentation. In response to transformation, autonomous virtual assist engine 310 is configured to compile the resource advancement assessment dashboard presentation 360, which is (i) is specific to the resource advancement requestor (e.g., loan applicant), (ii) summarizes and/or organizes the first resource advancement requestor data 210-1, (iii) identifies the one or more data omissions/anomalies 340 and (iv) includes the one or more recommended actions 342 for addressing the data omission(s)/anomalies 342.

In response to compiling resource advancement assessment dashboard presentation 360, autonomous virtual assist engine 310 is configured to communicate the resource advancement assessment dashboard presentation 360 to the user 120 (shown in FIGS. 1-3) for presentation on a dashboard application executing on an associated user device 130 (shown in FIGS. 1-3).

In further embodiments of the invention, autonomous virtual assist engine 310 is further configured to receive, via the resource advancement assessment dashboard application executing on user device 130 (shown in FIGS. 1-3), at least one on-demand resource advancement query 370 (i.e., queries inputted by user 120). In response to receiving the on-demand queries 370, autonomous virtual assist engine 310 is further configured to execute the one-demand resource advancement query(s) 370 by accessing the database 200 storing the resource advancement request/requestor data 210 and receiving second resource advancement request data 210-2 responsive to the on-demand resource advancement query(s) 370.

In response to receiving the second resource advancement request/requestor data 210-2, autonomous virtual assist engine 310 is further configured to perform dashboard format transformation 350 on the second resource advancement request/requestor data 210-2 to transform/convert the data 210-2 into a format compatible for dashboard presentation. In response to transformation 350, autonomous virtual assist engine 310 is further configured to update the resource advancement assessment dashboard presentation 360 to include the second resource advancement request/requestor data 210-1 and communicate the resource advancement assessment dashboard presentation 360 to the user device 130 (shown in FIGS. 1-3) for presentation on a dashboard application executing thereon.

Moreover, first memory 302 stores ML model 380 that has been trained to determine whether an on-demand query 370 should be included within the set of predetermined queries 320 (i.e., whether data 210-2 resulting from the on-demand query is relevant to all resource advancement requests). In this regard, Machine Learning (ML) model 380 receives an on-demand resource advancement query 370 and determines whether the on-demand resource advancement query 370 warrants inclusion in the set of predetermined resource advancement queries 320. If a determination is made by ML model 380 that the on-demand resource advancement query 370 should be included in the set of predetermined resource advancement queries 320, the set of predetermined resource advancement queries 320 is modified so as to include the on-demand resource advancement query 320.

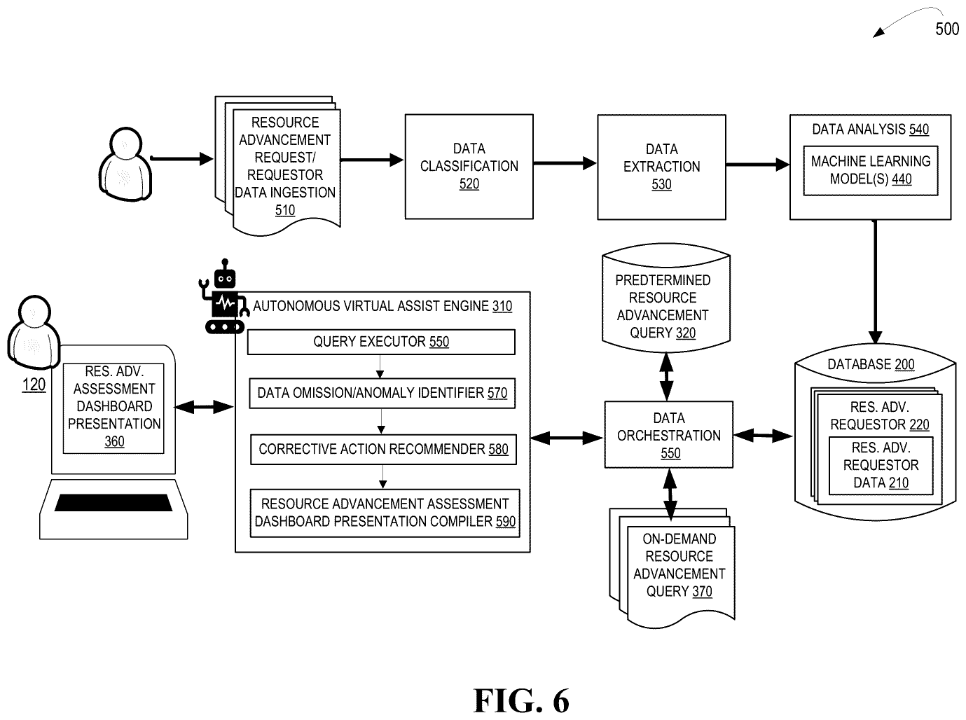

Referring to FIG. 6, a flow diagram is predicted of a methodology 500 for processing resource advancement requests, in accordance with embodiments of the present invention. At Event 510, resource advancement request/requestor data (210) is ingested into the system. In addition to a resource advancement requestor completing an online or physical resource advancement request application, ingestion may provide for scanning and/or uploading resource advancement request/requestor documents, such as, but not limited to, tax documents, pay stubs, W-2 tax forms, financial institution account statements, credit history, photo identification, renting history, and the like. At Event 520, the documents containing the resource advancement request/requestor data are classified and, at Event 530, the resource advancement request/requestor data is extracted from the various documents. At Event 540, the extracted data is communicated to the data analysis engine when various data verifications and assessments are performed. As previously discussed, in specific embodiments of the invention, data analysis provides for executing one or more machine learning models (440) as a means of verifying and/or assessing the resource advancement request/requestor data. Once the data has been analyzed, the resource advancement request/requestor data (210) is stored in database (200) that associates the data (210) with a corresponding resource advancement requestor 220 (e.g., loan applicant). It should be noted that once the resource advancement request is processed (e.g., approved or denied), the corresponding resource advancement request/requestor data may be stored in archive.

At Event 550, autonomous/intelligent virtual assist engine (310) executes queries, including predetermined resource advancement queries (320) and/or on-demand resource advancement queries (370). The execution of the queries (320, 370) is orchestrated, at Event 560, where communication with database (200) is facilitated to retrieve data 210 responsive to the queries (320, 370).

In response to receiving the data responsive to the queries (320, 370), at Event 570, the data is analyzed to identify data omissions/anomalies that would prevent approval of the resource advancement request and, at Event 580, if a data omission/anomaly is identified a corrective action is recommended for the data omission/anomaly. At Event 580, a resource advancement assessment dashboard presentation (360) is compiled that is specific to the resource advancement request and/or requestor and includes a summary of the resource advancement request/requestor data and, where applicable, highlights the data omissions and/or anomalies and provides the identified corrective action required to at least attempt to mitigate the data omission and/or data anomaly. In response to compiling the dashboard presentation (360), the dashboard presentation is communicated to a user device where an executing dashboard application presents the dashboard presentation (360) to the user (120).

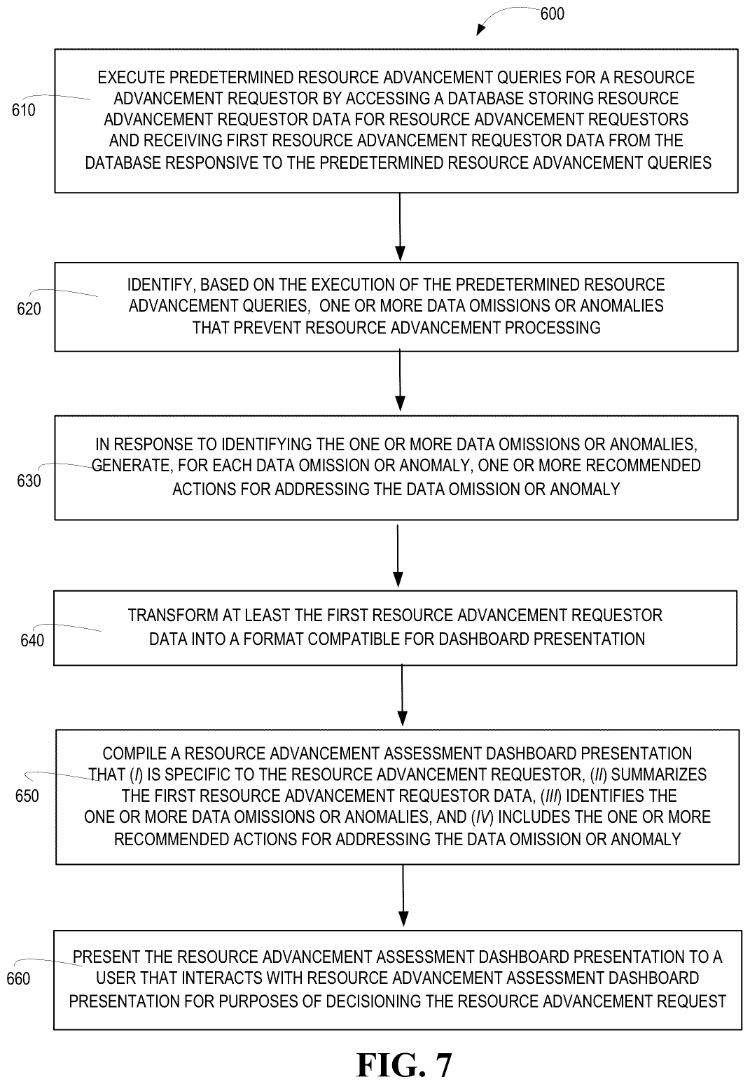

Referring to FIG. 7, a flow diagram is depicted of a method for processing a resource advancement request, in accordance with embodiments of the present invention. At Event 610, a set of predetermined resource advancement queries are executed by accessing a database storing resource advancement requestor data for resource advancement requestors and receiving first resource advancement requestor data from the database responsive to the predetermined resource advancement queries. As previously discussed, the execution of the set of predetermined resource advancement queries may be triggered by user requesting, within a dashboard application, a resource advancement request dashboard presentation for a specific resource advancement request and/or requestor.

In response to receiving first resource advancement requestor data responsive to the predetermined resource advancement queries, at Event 620, the data is analyzed to determine whether data omissions or data anomalies are present that would prevent approval of the resource advancement request. In response to determining/identifying one or more data omissions and/or data anomalies, at Event 630, corrective actions are identified or, if not pre-existing, generated for each data omission/anomaly that seek to mitigate the data omission and/or anomaly.

At Event 640, a resource advancement assessment dashboard presentation is compiled that is specific to a resource advancement request and/or resource advancement requestor. The resource advancement assessment dashboard presentation includes a summary of the resource advancement requestor/request data that was responsive to the predetermined queries and, where applicable, highlights data omissions and/or data anomalies and provided the identified/generated corrective actions that need to be taken to attempt to mitigate the data omission/anomaly. Once the resource advancement assessment dashboard presentation has been compiled, at Event 650, the resource advancement assessment dashboard presentation is communicated to a dashboard application executing on a user device for presentation purposes, such a user can efficiently and effectively use the data presented therein to decision a resource advancement request without having to access or be in possession of the resource advancement documents containing the resource advancement requestor/request data.

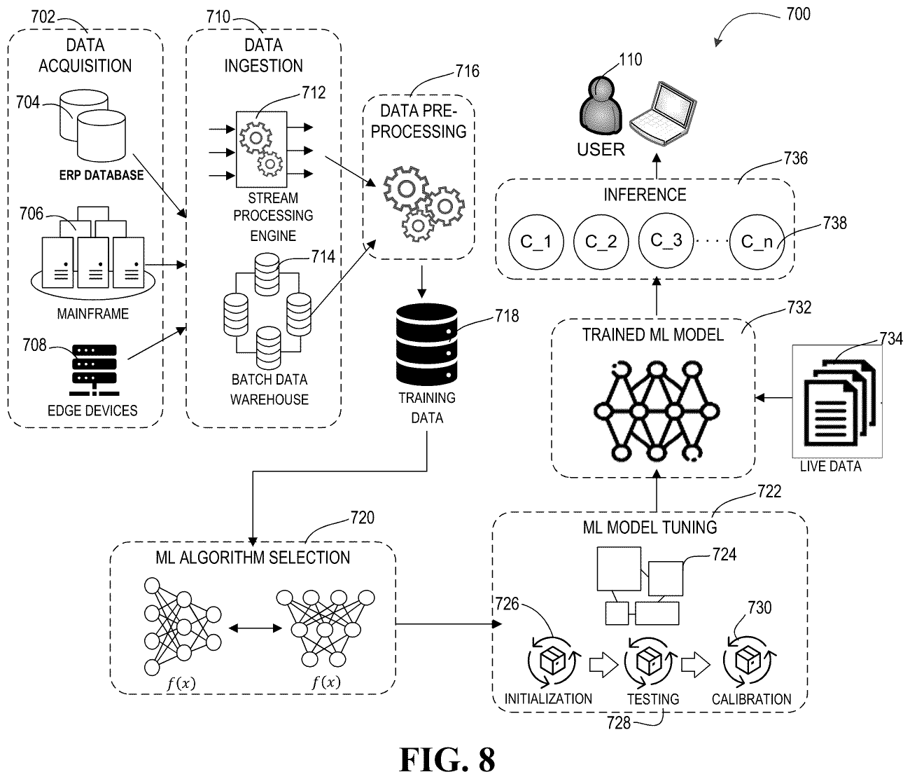

FIG. 8 illustrates an exemplary machine learning (ML) subsystem architecture 700, in accordance with embodiments of the present invention. The machine learning subsystem 700 may include a data acquisition engine 702, data ingestion engine 710, data pre-processing engine 716, ML model tuning engine 722, and inference engine 736.

The data acquisition engine 702 may identify various internal and/or external data sources to generate, test, and/or integrate new features for training the machine learning model 724. These internal and/or external data sources 704, 706, and 708 may be initial locations where the data originates or where physical information is first digitized. The data acquisition engine 702 may identify the location of the data and describe connection characteristics for access and retrieval of data. In some embodiments, data is transported from each data source 704, 706, or 708 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources may include Enterprise Resource Planning (ERP) databases 704 that host data related to day-to-day business activities such as accounting, procurement, project management, exposure management, supply chain operations, and/or the like, mainframe 706 that is often the entity's central data processing center, edge devices 708 that may be any piece of hardware, such as sensors, actuators, gadgets, appliances, or machines, that are programmed for certain applications and can transmit data over the internet or other networks, and/or the like. The data acquired by the data acquisition engine 702 from these data sources may then be transported to the data ingestion engine 710 for further processing.

Depending on the nature of the data imported from the data acquisition engine 702, the data ingestion engine 710 may move the data to a destination for storage or further analysis. Typically, the data imported from the data acquisition engine 702 may be in varying formats as they come from different sources, including RDBMS, other types of databases, S3 buckets, CSVs, or from streams. Since the data comes from different sources, it needs to be cleansed and transformed so that it can be analyzed together with data from other sources. At the data ingestion engine 702, the data may be ingested in real-time, using the stream processing engine 712, in batches using the batch data warehouse 714, or a combination of both. The stream processing engine 712 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 714 collects and transfers data in batches according to scheduled intervals, trigger events, or any other logical ordering.

In machine learning, the quality of data and the useful information that can be derived therefrom directly affects the ability of the machine learning model 724 to learn. The data pre-processing engine 716 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 716 may implement feature extraction and/or selection techniques to generate training data 718. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 718 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 722 may be used to train a machine learning model 724 using the training data 718 to make predictions or decisions without explicitly being programmed to do so. The machine learning model 724 represents what was learned by the selected machine learning algorithm 720 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, and the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, iterative dichotomiser 3, C4.5, chi-squared automatic interaction detection, decision stump, random forest, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, and the like), a clustering method (e.g., k-means clustering, expectation maximization, and the like), an associated rule learning algorithm (e.g., an Apriori algorithm, an Eclat algorithm, and the like), an artificial neural network model (e.g., a Perceptron method, a back-propagation method, a Hopfield network method, a self-organizing map method, a learning vector quantization method, and the like), a deep learning algorithm (e.g., a restricted Boltzmann machine, a deep belief network method, a convolution network method, a stacked auto-encoder method, and the like), a dimensionality reduction method (e.g., principal component analysis, partial least squares regression, Sammon mapping, multidimensional scaling, projection pursuit, and the like), an ensemble method (e.g., boosting, bootstrapped aggregation, AdaBoost, stacked generalization, gradient boosting machine method, random forest method, and the like), and/or the like.

To tune the machine learning model, the ML model tuning engine 722 may repeatedly execute cycles of experimentation (initialization) 726, testing 728, and calibration/tuning 730 to optimize the performance of the machine learning algorithm 720 and refine the results in preparation for deployment of those results for consumption or decision making. To this end, the ML model tuning engine 722 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 718. A fully trained machine learning model 732 is one whose hyperparameters are tuned and model accuracy maximized.

The trained machine learning model 732, similar to any other software application output, can be persisted to storage, file, memory, or application, or looped back into the processing component to be reprocessed. More often, the trained machine learning model 732 is deployed into an existing production environment to make practical business decisions based on live data 734. To this end, the machine learning subsystem 700 uses the inference engine 736 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 738) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 738) live data 734 based on how similar they are to one another to solve exploratory challenges where little is known about the data, provide a description or label (e.g., C_1, C_2 . . . . C_n 738) to live data 734, such as in classification, and/or the like. These categorized outputs, groups (clusters), or labels are then presented to the user input system 130. In still other cases, machine learning models that perform regression techniques may use live data 734 to predict or forecast continuous outcomes.

It will be understood that the embodiment of the machine learning subsystem 700 illustrated in FIG. 8 is exemplary and that other embodiments may vary. As another example, in some embodiments, the machine learning subsystem 700 may include more, fewer, or different components.

Thus, present embodiments of the invention discussed in detail above, provide for intelligent autonomous software (i.e., a “bot”) that compiles and presents resource advancement requestor-specific dashboard presentations that summarize the results of analysis of resource advancement data related to the resource advancement request and/or requestor. In compiling the dashboard presentation for a specific resource advancement requestor, the intelligent autonomous software is configured to execute a set of predetermined queries directed to a database that stores the results of the data analysis. In response to receiving the responses to the queries, the intelligent autonomous software is configured to identify data omissions and/or other anomalies in the data that will prevent approval of the resource advancement request and identify, and in some instances generate, corrective action(s) that will rectify the data omissions/anomalies. Subsequently, a resource advancement requestor-specific dashboard presentation is generated and communicated to the user that (i) summarizes the data responsive to the predetermined queries, and (ii) highlights the data omissions/anomalies and includes the corrective actions necessary to rectify the data omissions/anomalies.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for processing a resource advancement request, the system comprising:
a first computing platform including a first memory and one or more first computing processor devices in communication with the first memory; and
an autonomous virtual assist engine stored in the first memory, executable by at least one of the one or more first computing processor devices, and configured to:
execute predetermined resource advancement queries for a resource advancement requestor by accessing a database storing resource advancement requestor data for a plurality of resource advancement requestors and receiving first resource advancement requestor data responsive to the predetermined resource advancement queries,
identify, based on the execution of the predetermined resource advancement queries, one or more data omissions or anomalies that prevent resource advancement processing,
in response to identifying the one or more data omissions or anomalies, generate, for each data omission or anomaly, one or more recommended actions for addressing the data omission or anomaly,
transform the first resource advancement requestor data into a format compatible for dashboard presentation,
compile a resource advancement assessment dashboard presentation that (i) is specific to the resource advancement requestor, (ii) summarizes the first resource advancement requestor data, (iii) identifies the one or more data omissions or anomalies and (iv) includes the one or more recommended actions for addressing the data omission or anomaly, and
present the resource advancement assessment dashboard presentation to a user that interacts with resource advancement assessment dashboard presentation for purposes of decisioning the resource advancement request.

2. The system of claim 1, wherein the autonomous virtual assist engine is further configured to:
receive, via the resource advancement assessment dashboard, at least one on-demand resource advancement query from the user,
execute the at least one on-demand resource advancement query by accessing the database storing resource advancement request data and receiving second resource advancement request data responsive to the on-demand resource advancement queries,
transform the second resource advancement requestor data into the format compatible for dashboard presentation,
update the resource advancement assessment dashboard presentation to include the second resource advancement requestor data, and
present the updated resource advancement assessment dashboard presentation to the user.

3. The system of claim 2, wherein the autonomous virtual assist engine includes a predetermined query-determining machine learning (ML) model configured to receive the at least one on-demand resource advancement query and determine whether the predetermined resource advancement queries require modification based on the at least one on-demand resource advancement query.

4. The system of claim 1, further comprising:
a second computing platform including a second memory and one or more second computing processor devices in communication with the second memory; and
a data analysis engine stored in the second memory, executable by at least one of the one or more second computing processor devices, and configured to perform data verifications and data assessments on the resource advancement request data prior to storing the resource advancement request data in the database.

5. The system of claim 4, wherein the data analysis engine includes an incoming resource verification machine learning (ML) model configured to receive data related to incoming resources associated with a resource advancement requestor and based on the data, verify at least source and volume of incoming resources.

6. The system of claim 4, wherein the data analysis engine includes a real resource value assessment machine learning (ML) model configured to receive data related to one or more real resources held by a resource advancement requestor and based on the data, assess a value of real resources held by a resource advancement requestor.

7. The system of claim wherein the data analysis engine includes a resource advancement worthiness verification machine learning (ML) model configured to receive data related to resource advancement worthiness of a resource advancement requestor and based on the data, verify the resource advancement worthiness of the resource advancement requestor.

8. The system of claim wherein the data analysis engine includes a resource advancement target assessment machine learning (ML) model configured to receive data related to a resource advancement target that is a basis for the resource advancement and, based on the data, assess a value of the resource advancement target.

9. A computer-implemented method for processing a resource advancement request, the method being executable by one or more computing processor devices and comprising:
executing predetermined resource advancement queries for a resource advancement requestor by accessing a database storing resource advancement requestor data for a plurality of resource advancement requestors and receiving first resource advancement requestor data from the database that is responsive to the predetermined resource advancement queries;
identifying, based on the execution of the predetermined resource advancement queries, one or more data omissions or anomalies that prevent resource advancement processing;
in response to identifying the one or more data omissions or anomalies, generating, for each data omission or anomaly, one or more recommended actions for addressing the data omission or anomaly;
transforming at least the first resource advancement requestor data into a format compatible for dashboard presentation;
compiling a resource advancement assessment dashboard presentation that (i) is specific to the resource advancement requestor, (ii) summarizes the first resource advancement requestor data, (iii) identifies the one or more data omissions or anomalies, and (iv) includes the one or more recommended actions for addressing the data omission or anomaly; and
presenting the resource advancement assessment dashboard presentation to a user that interacts with resource advancement assessment dashboard presentation for purposes of decisioning the resource advancement request.

10. The computer-implemented method of claim 9, further comprising:
receiving, via the resource advancement assessment dashboard, at least one on-demand resource advancement query from the user;
executing the at least one on-demand resource advancement query by accessing the database storing resource advancement request data and receiving second resource advancement request data responsive to the on-demand resource advancement queries;
transforming the second resource advancement request data into the format compatible for dashboard presentation;
updating the resource advancement assessment dashboard presentation to include the second resource advancement request data; and
presenting the updated resource advancement assessment dashboard presentation to the user.

11. The computer-implemented method of claim 10, further comprising:
receiving, at a Machine Learning (ML) model, the at least one on-demand resource advancement query;
executing the ML model to determine whether the predetermined resource advancement queries require modification based on the at least one on-demand resource advancement query; and
in response to determining that the predetermined resource advancement queries require modification, modifying the predetermined resource advancement queries.

12. The computer-implemented method of claim 10, further comprising:
performing data verifications and data assessments on the resource advancement request data prior to storing the resource advancement request data in the database.

13. The computer-implemented method of claim 10, wherein performing further comprises:
receiving, at a Machine Learning (ML) model), data related to incoming resources associated with a resource advancement requestor; and,
in response to receiving the data, executing the ML model to verify at least source and volume of incoming resources.

14. The computer-implemented method of claim 10, wherein performing further comprises:
receiving, at a Machine Learning (ML) model), data related to one or more real resources held by a resource advancement requestor; and,
in response to receiving the data, executing the ML model to assess a value of real resources held by a resource advancement requestor.

15. The computer-implemented method of claim 10, wherein performing further comprises:
receiving, at a Machine Learning (ML) model), data related to resource advancement worthiness of a resource advancement requestor; and,
in response to receiving the data, executing the ML model to verify the resource advancement worthiness of the resource advancement requestor.

16. The computer-implemented method of claim 10, wherein performing further comprises:
receiving, at a Machine Learning (ML) model), data related to a resource advancement target that is a basis for the resource advancement; and,
in response to receiving the data, executing the ML model to assess a value of the resource advancement target.

17. A computer program product comprising:
a non-transitory computer-readable medium comprising sets of codes for causing one or more computing devices to:
execute predetermined resource advancement queries for a resource advancement requestor by accessing a database storing resource advancement requestor data for a plurality of resource advancement requestors and receiving first resource advancement requestor data responsive to the predetermined resource advancement queries;
identify, based on the execution of the predetermined resource advancement queries, one or more data omissions or anomalies that prevent resource advancement processing;
in response to identifying the one or more data omissions or anomalies, generate, for each data omission or anomaly, one or more recommended actions for addressing the data omission or anomaly;
transform at least the first resource advancement request data into a format compatible for dashboard presentation;
compile a resource advancement assessment dashboard presentation that (i) is specific to the resource advancement requestor, (ii) summarizes the first resource advancement request data, (iii) identifies the one or more data omissions or anomalies and (iv) includes the one or more recommended actions for addressing the data omission or anomaly; and
present the resource advancement assessment dashboard presentation to a user that interacts with resource advancement assessment dashboard presentation for purposes of decisioning the resource advancement request.

18. The computer program product of claim 17, wherein the sets of codes further comprise sets of codes configured to cause the one or more computing devices to:
receive, via the resource advancement assessment dashboard, at least one on-demand resource advancement query from the user;
execute the at least one on-demand resource advancement query by accessing the database storing resource advancement request data and receiving second resource advancement request data responsive to the on-demand resource advancement queries;
transform the second resource advancement request data into the format compatible for dashboard presentation; and
update the resource advancement assessment dashboard presentation to include the second resource advancement request data; and
present the updated resource advancement assessment dashboard presentation to the user.

19. The computer program product of claim 17, wherein the sets of codes further comprise sets of codes configured to cause the one or more computing devices to:
receive, at a Machine Learning (ML) model, the at least one on-demand resource advancement query;
execute the ML model to determine whether the predetermined resource advancement queries require modification based on the at least one on-demand resource advancement query; and
in response to determining that the predetermined resource advancement queries require modification, modify the predetermined resource advancement queries.

20. The computer program product of claim 17, wherein the sets of codes further comprise sets of codes configured to cause the one or more computing devices to:
perform data verifications and data assessments on the resource advancement request data prior to storing the resource advancement request data in the database.
